(19) United States
(12) Patent Application Publication
(10) Pub. No.: US 2003/0118825 A1
(43) Pub. Date: Jun. 26, 2003

(54) Microwave heatable absorbent composites

(75) Inventors: Shannon K. Melius, Appleton, WI (US); William G. Reeves, Appleton, WI (US); Peter R. Elliker, Appleton, WI (US)

Correspondence Address: KIMBERLY-CLARK WORLDWIDE, INC., 401 NORTH LAKE STREET, NEENAH, WI, 54956

(73) Assignee: Kimberly-Clark Worldwide,Inc

(21) Appl. No.: 10/324,528

(22) Filed: Dec. 18, 2002

Related U.S. Application Data
(63) Continuation-in-part of application No. 10/036,864, filed on Dec. 21, 2001.

(51) Int. Cl. B32B 5/16

(52) U.S. Cl. 428/407

(57) ABSTRACT

Absorbent composites are described as containing a particle of superabsorbent material covered with an energy receptive additive. The absorbent composites are suitable for exposure to dielectric heating, in general, and microwave heating, in particular.

### CROSS-REFERENCE TO RELATED APPLICATION

This is a continuation-in-part application of U.S. application Ser. No. 10/036,864, filed Dec. 21, 2001, and entitled “Nonwoven Web With Coated Superabsorbent” (Atty. Docket No. 16,282).

### FIELD OF INVENTION

The present invention relates to absorbent composites suitable for exposure to dielectric heating. More particularly, the present invention relates to an absorbent composite having a superabsorbent material and an energy receptive additive, the energy receptive additive heating up in the presence of microwave energy.

### BACKGROUND

In the general practice of forming fibrous web materials, such as airformed webs of absorbent material, it has been common to utilize a fibrous sheet of cellulosic or other suitable absorbent material which has been fiberized in a conventional fiberizer, or other shredding or comminuting device, to form discrete fibers. In addition, particles of superabsorbent material have been mixed with the fibers. The fibers and superabsorbent particles have then been entrained in an air stream and directed to a porous, foraminous forming surface upon which the fibers and superabsorbent particles have been deposited to form an absorbent fibrous web.

To form a stabilized airlaid web, binder materials have been added to the web structure. Such binder materials have included adhesives, powders, netting and binder fibers. The binder fibers have included one or more of the following types of fibers: homofilaments, heat-fusible fibers, bicomponent fibers, meltblown polyethylene fibers, meltblown polypropylene fibers, and the like.

Conventional systems for producing stabilized airlaid fibrous webs have mixed the binder fibers with absorbent fibers, and then deposited the mixed fibers onto a porous forming surface by using a vacuum system to draw the fibers onto the forming surface. Typically such conventional systems have required the use of excessive amounts of energy. Where the binder fibers are heat-activated to provide the stabilized web structure, it has often been necessary to subject the fibrous web to an excessively long heating time to adequately heat the binder fibers. For instance, a typical heating time for a through-air bonding system would be about 8 seconds. Additionally, it has been necessary to subject the fibrous web to an excessively long cooling time, such as during roll storage in warehouses, to establish and preserve the desired stabilized structure prior to further processing operations. As a result, such conventional systems have been inadequate for manufacturing stabilized airlaid webs directly in-line on high-speed machines.

Recently, however, techniques have been developed for manufacturing stabilized airlaid webs directly in-line on high-speed machines. These techniques can include: an airforming of a fibrous layer; and an exposing of the fibrous layer to dielectric energy during a distinctively short (e.g., less than about 3 seconds) activation period to activate the binder-fibers to provide the stabilized airlaid layer.

While such high-speed techniques of in-line manufacture have many advantages, exposing a fibrous layer containing particles of conventional superabsorbent material to dielectric heating does have its disadvantages. One disadvantage is the susceptibility of conventional superabsorbent material to explode or pop (similar to popcorn) when exposed to dielectric heating. Another disadvantage is the susceptibility of conventional superabsorbent material to arcing when exposed to dielectric heating. As a result of the superabsorbent material arcing, the fibrous layer may ignite or no longer be suitable for incorporation into personal care products such as diapers, children's training pants, adult incontinence garments, medical garments, sanitary napkins, and the like. Moreover, arcing in many methods of manufacture is viewed as undesirable for a variety of safety concerns.

### SUMMARY

The present inventors have recognized the difficulties and problems inherent in incorporating conventional superabsorbent material into fibrous layers that are thereafter subjected to dielectric heating. In response thereto, the present inventors conducted intensive research toward the development of absorbent composites capable of being subjected to dielectric heating, in general, and microwave heating, in particular. The absorbent composites of the present invention are believed to minimize or eliminate the exploding or popping that often occurs when a particle of conventional superabsorbent material is exposed to dielectric heating. Moreover, the absorbent composites of the present invention are believed to minimize or eliminate the amount of arcing that often occurs when a particle of conventional superabsorbent material is exposed to dielectric heating. By reducing or eliminating arcing, the absorbent composites of the present invention may be incorporated into a fibrous layer that is thereafter subjected to dielectric heating. Any reduction or elimination of arcing would have a positive impact on the amount of waste that often occurs in the manufacture of absorbent bodies that are exposed to dielectric heating. Moreover, any reduction or elimination of arcing would increase the level of safety associated with manufacturing absorbent bodies that are subjected to dielectric heating.

In one embodiment, the absorbent composite includes a superabsorbent material and an energy receptive additive. The energy receptive additive has a dielectric loss tangent of at least about 0.15.

In another embodiment, the absorbent composite has a superabsorbent material and an energy receptive additive. The energy receptive additive has a dielectric constant of at least about 4.

In an alternative embodiment, a microwave heatable absorbent composite includes a superabsorbent material and an energy receptive additive. The energy receptive additive is in intimate association with and covers the surface of the superabsorbent material. Moreover, the energy receptive additive heats up in the presence of microwave energy.

### DRAWINGS

The foregoing and other features, aspects and advantages of the present invention will become better understood with regard to the following description, appended claims and accompanying drawings where:

FIG. 1 illustrates a representative fluidized bed coating apparatus.

### DESCRIPTION

The absorbent composites of the present invention include a superabsorbent material covered with an energy receptive additive.

A wide variety of materials can be suitably employed as the superabsorbent material of the present invention. It is desired, however, to employ superabsorbent material in particle form capable of absorbing large quantities of fluids, such as water, urine or other bodily fluid, and of retaining such absorbed fluids under moderate pressures. It is even more desired to use relatively inexpensive and readily obtainable superabsorbent materials.

By “particle,” “particles,” “particulate,” “particulates,” and the like, it is meant that a material is generally in the form of discrete units. The particles can include granules, pulverulents, powders, or spheres. Thus, the particles can have any desired shape such as, for example, cubic, rod-like, polyhedral, spherical or semi-spherical, rounded or semi-rounded, angular, irregular, etc. Shapes having a large greatest dimension/smallest dimension ratio, like needles, flakes and fibers, are also contemplated for use herein. The use of “particle” or “particulate” may also describe an agglomeration including more than one particle, particulate, or the like.

As used herein, “superabsorbent material,” “superabsorbent materials” and the like are intended to refer to a water-swellable, water-insoluble organic or inorganic material capable, under the most favorable conditions, of absorbing at least about 10 times its weight and, desirably, at least about 15 times its weight in an aqueous solution containing 0.9 weight percent of sodium chloride. Such materials include, but are not limited to, hydrogel-forming polymers which are alkali metal salts of: poly(acrylic acid); poly(methacrylic acid); copolymers of acrylic and methacrylic acid with acrylamide, vinyl alcohol, acrylic esters, vinyl pyrrolidone, vinyl sulfonic acids, vinyl acetate, vinyl morpholinone and vinyl ethers; hydrolyzed acrylonitrile grafted starch; acrylic acid grafted starch; maleic anhydride copolymers with ethylene, isobutylene, styrene, and vinyl ethers; polysaccharides such as carboxymethyl starch, carboxymethyl cellulose, methyl cellulose, and hydroxypropyl cellulose; poly(acrylamides); poly(vinyl pyrrolidone); poly(vinyl morpholinone); poly(vinyl pyridine); and copolymers, and mixtures of any of the above and the like. The hydrogel-forming polymers are desirably lightly cross-linked to render them substantially water-insoluble. Cross-linking may be achieved by irradiation or by covalent, ionic, van der Waals attractions, or hydrogen bonding interactions, for example. A desirable superabsorbent material is a lightly cross-linked hydrocolloid. Specifically, a more desirable superabsorbent material is a partially neutralized polyacrylate salt.

Superabsorbent material employed in the present invention suitably should be able to absorb a liquid under an applied load. For purposes of the present invention, the ability of a superabsorbent material to absorb a liquid under an applied load and thereby perform work is quantified as the Absorbency Under Load (AUL) value. The AUL value is expressed as the amount (in grams) of an approximately 0.9 weight percent saline (sodium chloride) solution absorbed by about 0.160 grams of superabsorbent material when the superabsorbent material is under a load. Common loads include those of about 0.29 pound per square inch, 0.57 pound per square inch, and about 0.90 pound per square inch. Superabsorbent materials suitable for use herein desirably are stiff-geling superabsorbent materials having an AUL value under a load of about 0.29 pound per square inch of at least about 7; alternatively, at least about 9; alternatively, at least about 15; alternatively, at least about 20; alternatively, at least about 24; and, finally, alternatively, at least about 27 g/g. (Although known to those skilled in the art, the gel stiffness or shear modulus of a superabsorbent material is further described in U.S. Pat. No. 5,147,343 to Kellenberger and/or U.S. Pat. No. 5,601,542 to Melius et al., the disclosure of each of which is incorporated herein by reference to the extent that each is consistent (i.e., does not conflict) with the present specification.) Useful superabsorbent materials are well known in the art, and are readily available from various suppliers. For example, FAVOR SXM 880 superabsorbent material is available from Stockhausen, Inc., a business having offices located in Greensboro, N.C., U.S.A.; and DRYTECH 2035 superabsorbent material is available from Dow Chemical Company, a business having offices located in Midland, Mich., U.S.A.

Suitably, the superabsorbent material is in the form of particles which, in the unswollen state, have maximum cross-sectional diameters ranging between about 50 and about 1,000 microns; desirably, between about 100 and about 800 microns; more desirably between about 200 and about 650 microns; and most desirably, between about 300 and about 600 microns, as determined by sieve analysis according to American Society for Testing Materials Test Method D-1921. It is understood that the particles of superabsorbent material may include solid particles, porous particles, or may be agglomerated particles including many smaller particles falling within the described size ranges.

The absorbent composites of the present invention also include an energy receptive additive. In such an instance, the energy receptive additive is in intimate association with and covering the surface of the superabsorbent material. Suitable energy receptive additives may be in particulate, liquid or semi-liquid form and are capable of becoming excited when subjected to dielectric heating. In addition, suitable energy receptive additives absorb microwave energy efficiently, converting it to heat.

Use of “cover,” “covers,” “covering” or “covered” with regard to an energy receptive additive is intended to indicate that the energy receptive additive extends over the surface of the material being covered to the extent necessary to realize many of the advantages of the present invention. This includes situations where the energy receptive additive extends over at least about 10 percent of the surface of the material being covered; alternatively, over at least about 20 percent of the surface of the material being covered; alternatively, over at least about 30 percent of the surface of the material being covered; alternatively, over at least about 40 percent of the surface of the material being covered; alternatively, over at least about 50 percent of the surface of the material being covered; alternatively, over at least about 60 percent of the surface of the material being covered; alternatively, over at least about 70 percent of the surface of the material being covered; alternatively, over at least about 80 percent of the surface of the material being covered; and finally, alternatively, over at least about 90 percent of the surface of the material being covered. The term “surface” and its plural generally refer herein to the outer or the topmost boundary of an object.

As used herein, the phrase “intimate association” and other similar terms are intended to encompass configurations including the following: those where at least a portion of an energy receptive additive is in contact with a portion of the surface of at least one particle of superabsorbent material; and/or those where at least a portion of an energy receptive additive is in contact with a portion of another energy receptive additive such as in, for example, a layered or mixed configuration.

In order to be industrially applicable, a suitable energy receptive additive absorbs energy at the desired frequency (typically between about 0.01 to about 300 GHz) very rapidly, in the range of fractions of a second; alternatively, less than about a quarter of a second; alternatively, less than about a half of a second; and at most about one second.

A suitable energy receptive additive should have a dielectric loss factor that is relatively high. The dielectric loss factor is a measure of how receptive to high frequency energy a material is. The measured value of ε′ is most often referred to as the dielectric constant, while the measurement of ε″ is denoted as the dielectric loss factor. These values can be measured directly using a Network Analyzer with a low power external electric field (i.e., 0 dBm to about +5 dBm) typically over a frequency range of about 300 kHz to about 3 GHz, although Network Analyzers to 20 GHz are readily available. For example, a suitable measuring system can include an HP8720D Dielectric Probe and a model HP8714C Network Analyzer, both available from Agilent Technologies, a business having offices located in Brookfield, Wis., U.S.A. Substantially equivalent devices may also be employed. By definition, ε″ is always positive; however, a value of less than zero is occasionally observed when ε″ is near zero due to the measurement error of the analyzer. The dielectric loss tangent is defined as the calculated ratio of ε″/ε′. This dielectric loss tangent (tan δ) results as the vector sum of the orthogonal real (ε′) and imaginary (ε″) parts of the complex relative permittivity (εᵣ) of a sample. The vector sum of the real and imaginary vectors creates an angle (δ) where tan δ is the analytical geometry equivalent to the ratio of ε″/ε′. Energy receptive additives useful in the present invention typically have a dielectric constant—measured in the frequency range of about 900 to about 3,000 MHz—of at least about 4; alternatively, at least 4; alternatively, at least about 8; alternatively, at least 8; alternatively, at least about 15; or alternatively, at least 15. Stated differently, the energy receptive additives suitable for use in the present invention have a dielectric loss tangent—measured in the frequency range of about 900 to about 3,000 MHz—of at least about 0.15; alternatively, at least 0.15; alternatively, at least about 0.25; alternatively, at least 0.25; alternatively, at least about 0.5; or alternatively, at least 0.5. It should be noted that the dielectric constant and dielectric loss tangent are dimensionless.

Examples of materials that may be suitable energy receptive additives, followed by their dielectric constants are: titanium dioxide (110), hydrogen peroxide at 0° C. (84.2), water at 20° C. (80.4), methyl alcohol at −80° C. (56.6), glycerol at 25° C. (42.5), titanium oxide (40-50), glycol at 25° C. (37), sorbitol at 80° C. (33.5), ethanol at 25° C. (24.3), propanol at 80° C. (20.1), ferrous sulfate at 14° C. (14.2), ferrous oxide at 15.5° C. (14.2), calcium superphosphate (14-15), zircon (12), graphite or high density carbon black (1215), calcium oxide granules (11.8), barium sulfate at 15.5° C. (11.4), ruby (11.3), silver chloride (11.2), silicon (11-12), hydrogenated castor oil at 27° C. (10.3), magnesium oxide (9.7), alumina (9.3-11.5), anhydrous sodium carbonate (8.4), calcite (8), mica (7), dolomite (6.8-8). Other examples include, but are not limited to, various mixed valent oxides such as magnetite (Fe₃O₄), nickel oxide (NiO) and such; ferrite, tin oxide, carbon, carbon black and graphite; sulfide semiconductors such as FeS₂, CuFeS₂; silicon carbide; various metal powders such as aluminum, iron and the like; various hydrated salts and other salts, such as calcium chloride dihydrate; diatomaceous earth; adipic acids; aliphatic polyesters, e.g., polybutylene succinate and poly(butylene succinate-co-adipate), polymers and co-polymers of polylactic acid, polymers such as PEO and copolymers of PEO, including PEO grafted with polar acrylates; various hygroscopic or water absorbing materials or more generally polymers or copolymers or non-polymers with many sites with —OH groups; other inorganic microwave absorbers including aluminum hydroxide, zinc oxide, barium titanate and other organic absorbers such as polymers containing ester, aldehyde, ketone, isocyanate, phenol, nitrile, carboxyl, vinylidene chloride, ethylene oxide, methylene oxide, epoxy, amine groups, polypyrroles, polyanilines, polyalkylthiophenes, and mixtures thereof.

It should be further noted that the present invention is not limited to the use of only one energy receptive additive, but could also include mixtures of two or more energy receptive additives. As previously indicated, the energy receptive additive may be in particulate form; consequently, it is understood that the particles of energy receptive additive may include solid particles, porous particles, or may be an agglomeration of more than one particle of energy receptive additive. One skilled in the art would readily appreciate the possibility of treating the surface of a particle of energy receptive additive to enhance its ability to efficiently absorb microwave energy. Suitable surface treatments include scoring, etching, and the like. The energy receptive additive may also be in the form of a liquid or semi-liquid. In particular, a solution, dispersion or emulsion of one or more effective energy receptive additives may be formulated. Such a liquid or semi-liquid formulation may be deposited on the surface of superabsorbent material in the form of finely atomized droplets or by any of a variety of other known methods including spraying or blowing in the form of steam, and the like. When so deposited, at least a portion of the energy receptive additive would come into intimate association with and cover at least a portion of the surface of a particle of superabsorbent material.

In various embodiments of the present invention, the intimate association of an energy receptive additive with a superabsorbent material may be achieved with the optional use of an association agent. The association agent usually includes substances that can be applied in liquid or semi-liquid form to either the superabsorbent material or the energy receptive additive. The term “applied” as used herein is intended to include situations where: at least a portion of the surface of a particle of superabsorbent material has an effective amount of association agent on it to facilitate adherence, via mechanical and/or chemical bonding, of at least a portion of the surface of the superabsorbent material to at least a portion of an energy receptive additive; at least a portion of an energy receptive additive has an effective amount of association agent on it to facilitate adherence, via mechanical and/or chemical bonding, of at least a portion of the energy receptive additive to a portion of the surface of a particle of superabsorbent material; and/or at least a portion of an energy receptive additive has an effective amount of association agent on it to facilitate adherence, via mechanical and/or chemical bonding, of at least a portion of an energy receptive additive to a portion of another energy receptive additive. Desirably, the association agent is applied to the selected material in an amount of from about 99:1 to about 1:99, by weight.

The selection of a particular association agent can be made by one skilled in the art and will typically depend upon the chemical composition of the materials to be maintained in intimate association with one another. Desirably, the association agent is suitable for use in applications involving human contact. Thus, the association agent should be non-toxic and non-irritating to humans. An association agent suitable for use in the present invention is typically prepared by the formation of a liquid or semi-liquid capable of being generally uniformly atomized. In particular, a solution, dispersion or emulsion including at least one of the association agents identified herein may be prepared. Although the association agent is described herein as being applied as finely atomized droplets, it may be applied to the selected material by any other method such as by spraying in liquid or semi-liquid form, spraying and blowing in the form of steam, and the like.

Several types of association agent are capable of being employed in the present invention. Illustrative association agents suitable for use in various embodiments of the present invention include, for example: water; volatile organic solvents such as alcohols; aqueous solutions of film-forming materials such as dried milk, lactose, soluble soy protein, and casein; synthetic adhesives such as polyvinyl alcohol; and mixtures thereof. The presence of water in the association agent is particularly effective in predisposing the superabsorbent material to wetting.

The absorbent composites of the present invention are believed to be suitable for use in a variety of disposable absorbent articles including, but not limited to: health care related products including ostomy products, surgical drapes, gowns, and sterilization wraps; personal care absorbent products such as feminine hygiene products, diapers, training pants, incontinence products and the like; as well as facial tissues. In general, the absorbent composites may be used in a manner similar to that in which conventional superabsorbents have been used: for example, in laminates, in relatively high density cores (i.e., compacted cores, calendered cores, densified cores, etc.), or in relatively low density cores (i.e., not compacted, for example, airlaid cores). Absorbent articles having stabilized absorbent structures which include the absorbent composites discussed herein are disclosed in U.S. application Ser. No. ______, entitled “Absorbent Article With Stabilized Absorbent Structure,” which was filed contemporaneously herewith on Dec. 18, 2002, (Atty. Docket No. 16820.4), the entire disclosure of which is incorporated herein by reference in a manner that is consistent with the present specification.

The absorbent composites of the present invention, however, are believed to provide certain advantages over conventional superabsorbent material. For example, the present inventors believe that an absorbent composite of the present invention may be exposed to microwave energy while minimizing or eliminating the exploding or popping commonly associated with the microwave heating of a particle of superabsorbent material that does not have an energy receptive additive covering its surface. Conventional convective heating of a particle of conventional superabsorbent material causes the water within the particle to move toward the surface of the particle at the water diffusion rate of the particle itself. The passive diffusion rate is believed to be approximately proportional to the material matrix density of the particle. In contrast, the dielectric heating of a particle of conventional superabsorbent material raises the internal temperature of the particle rapidly driving water to the surface via an active transport. Without desiring to be bound by theory, it is believed that the microwave heating of a particle of conventional superabsorbent material during a relatively short activation period drives water to the surface of the particle at a rate sufficient to oftentimes cause the particle to explode or pop.

The present inventors further believe that an absorbent composite of the present invention may be exposed to microwave energy while minimizing or eliminating the arcing commonly associated with the microwave heating of a particle of superabsorbent material that does not have an energy receptive additive covering its surface. Without desiring to be bound by theory, it is believed that energy receptive additives suitable for use in the present invention absorb energy, such as radio frequency (RF) or microwave energy, more rapidly than the superabsorbent material and thus heat faster than the superabsorbent material. When incorporated into, for example, the manufacture of stabilized airlaid webs directly in-line on high-speed machines, the energy receptive additive will heat faster than the superabsorbent material. By heating faster than the superabsorbent material, the energy receptive additive will activate any adjacent binder fibers thereby stabilizing the airlaid web. The absorbent composites of the present invention would therefore allow for the activation of binder fibers to form stabilized structures at higher speeds, shorter heating times, and lower energy levels.

Energy receptive additives can be receptive to various specific spectra of energy. Just as a black item will absorb more energy and become warmer than the same item colored white when subjected to the same amount of solar energy, energy receptive additives will absorb energy at their specific wavelength, directed at them. One method of providing energy to an energy receptive additive is via dielectric heating (e.g., RF or microwave heating).

Dielectric heating is the term applied to the generation of heat in non-conducting materials by their losses when subject to an alternating electric field of high frequency. The frequencies necessarily range from about 0.01 to about 300 GHz (billion cycles/sec). Heating of non-conductors by this method is extremely rapid. This form of heating is applied by placing the non-conducting material between two electrodes, across which the high-frequency voltage is applied. This arrangement in effect constitutes an electric capacitor, with the load acting as the dielectric. Although ideally a capacitor has no losses, losses do occur in practice and sufficient heat is generated at high frequencies to make this a viable form of heating.

The frequency used in dielectric heating is a function of the power desired and the size of the work material. Practical values of voltages applied to the electrodes are about 2000 to about 5000 volts/in of thickness of the work material. The source of power is by electronic oscillators that are capable of generating the very high frequencies desired.

The basic requirement for dielectric heating is the establishment of a high-frequency alternating electric field within the material or load to be heated. Once the electric field has been established, the second requirement involves dielectric loss properties of the material to be heated. The dielectric loss of a given material occurs as a result of electrical polarization effects in the material itself and may be through dipolar molecular rotation and ionic conduction. The higher the dielectric loss of a material, the more receptive to the high frequency energy it is.

RF heating occurs at about 27 MHz and heats by providing about half the total power delivered as ionic conduction to the molecules within the workpiece, with the remainder of the power delivered as dipolar molecular rotation. Microwave heating is dielectric heating at still higher frequencies. The predominate frequencies used in industrial microwave heating are 915 and 2450 MHz, although other frequencies may be used and particular energy receptive additives may be found to be receptive at only particular frequencies. Microwave heating is about 10 to about 100 times higher in frequency than the usual dielectric heating, resulting in a lower voltage requirement if the dielectric loss is constant, although the dielectric loss is generally higher at microwave frequencies.

The absorbent composites of the present invention may be prepared in a manner similar to fluidized bed coating processes. In one embodiment of such a process, at least one particle of an energy receptive additive is suspended in a fluidized bed coating apparatus that creates a strong upward current or stream of fluidizing gas, usually air, typically at an inlet temperature approximating that of room temperature. The strong upward current or stream of fluidizing gas moves the energy receptive additive upward until the energy receptive additive passes out of the upward stream and passes downward in a fluidized condition countercurrent to the upward stream of fluidizing gas. The energy receptive additive may re-enter the upward-moving stream of fluidizing gas. While in the upward-moving stream, the energy receptive additive passes through a zone where an association agent is applied to the energy receptive additive. After the association agent is applied to the energy receptive additive, at least one particle of superabsorbent material is introduced into the apparatus. A strong upward current or stream of fluidizing gas, usually air, optionally at an elevated inlet temperature (i.e., a temperature typically above room temperature), moves the energy receptive additive and the superabsorbent material upward until the energy receptive additive and the superabsorbent material pass out of the upward stream and pass downward in a fluidized condition countercurrent to the upward stream of fluidizing gas. The energy receptive additive and the superabsorbent material may re-enter the upward-moving stream of fluidizing gas until an absorbent composite is formed. Typically, it is after the association agent is applied that the energy receptive additive would come into intimate association with the superabsorbent material to form an absorbent composite. The absorbent composite so formed would include at least one particle of superabsorbent material covered with at least a first layer of at least one particle of energy receptive additive. The energy receptive additive of the first layer would be in intimate association with and covering the surface of the superabsorbent material.

The absorbent composites of the present invention may also be prepared by another embodiment of the process described herein. In this embodiment, at least one particle of a superabsorbent material is suspended in a fluidized bed coating apparatus that creates a strong upward current or stream of fluidizing gas, usually air, typically at an inlet temperature approximating that of room temperature. The strong upward current or stream of fluidizing gas moves the superabsorbent material upward until the superabsorbent material passes out of the upward stream and passes downward in a fluidized condition countercurrent to the upward stream of fluidizing gas. The superabsorbent material may re-enter the upward-moving stream of fluidizing gas. While in the upward-moving stream, the superabsorbent material passes through a zone where an association agent is applied to the superabsorbent material. After the association agent is applied to the superabsorbent material, at least one particle of energy receptive additive is introduced into the apparatus. A strong upward current or stream of fluidizing gas, usually air, optionally at an elevated inlet temperature, moves the energy receptive additive and the superabsorbent material upward until the energy receptive additive and the superabsorbent material pass out of the upward stream and pass downward in a fluidized condition countercurrent to the upward stream of fluidizing gas. The energy receptive additive and the superabsorbent material may re-enter the upward-moving stream of fluidizing gas until an absorbent composite is formed. Typically, it is after the association agent is applied that the energy receptive additive would come into intimate association with the superabsorbent material to form an absorbent composite. The absorbent composite so formed would include at least one particle of superabsorbent material covered with at least a first layer of at least one particle of energy receptive additive. The energy receptive additive of the first layer would be in intimate association with and covering the surface of the superabsorbent material.

The absorbent composites of the present invention may also be prepared by still another embodiment of the process described herein. In this embodiment, at least one particle of energy receptive additive and at least one particle of superabsorbent material are suspended in a fluidized bed coating apparatus that creates a strong upward current or stream of fluidizing gas, usually air, typically at an inlet temperature approximating that of room temperature. The strong upward current or stream of fluidizing gas moves both the energy receptive additive and the superabsorbent material upward until the energy receptive additive and the superabsorbent material pass out of the upward stream and pass downward in a fluidized condition countercurrent to the upward stream of fluidizing gas. The energy receptive additive and the superabsorbent material may re-enter the upward-moving stream of fluidizing gas. While in the upward-moving stream, the energy receptive additive and the superabsorbent material pass through a zone where an association agent is applied to both the energy receptive additive and superabsorbent material. After the association agent is applied, the strong upward-moving stream of fluidizing gas, usually air, optionally at an elevated inlet temperature, moves the energy receptive additive and the superabsorbent material upward until the energy receptive additive and the superabsorbent material pass out of the upward stream and pass downward in a fluidized condition countercurrent to the upward stream of fluidizing gas. The energy receptive additive and the superabsorbent material may re-enter the upward-moving stream of fluidizing gas until an absorbent composite is formed. Typically, it is after the association agent is applied that the energy receptive additive would come into intimate association with the superabsorbent material to form an absorbent composite. The absorbent composite so formed would include at least one particle of superabsorbent material covered with at least a first layer of at least one particle of energy receptive additive. The energy receptive additive of the first layer would be in intimate association with and covering the surface of the superabsorbent material.

The absorbent composites of the present invention may also be prepared by yet another embodiment of the process described herein. In this embodiment, at least one particle of a superabsorbent material is suspended in a fluidized bed coating apparatus that creates a strong upward current or stream of fluidizing gas, usually air, typically at an inlet temperature approximating that of room temperature. The strong upward current or stream of fluidizing gas moves the superabsorbent material upward until the superabsorbent material passes out of the upward stream and passes downward in a fluidized condition countercurrent to the upward stream of fluidizing gas. The superabsorbent material may re-enter the upward-moving stream of fluidizing gas. While in the upward-moving stream, the superabsorbent material passes through a zone where an energy receptive additive, in liquid or semi-liquid form, is deposited on and covers the surface of the superabsorbent material. The energy receptive additive and the superabsorbent material may re-enter the upward-moving stream of fluidizing gas until an absorbent composite is formed. The absorbent composite so formed would include at least one particle of superabsorbent material covered with an energy receptive additive. The energy receptive additive would be in intimate association with and covering the surface of the superabsorbent material.

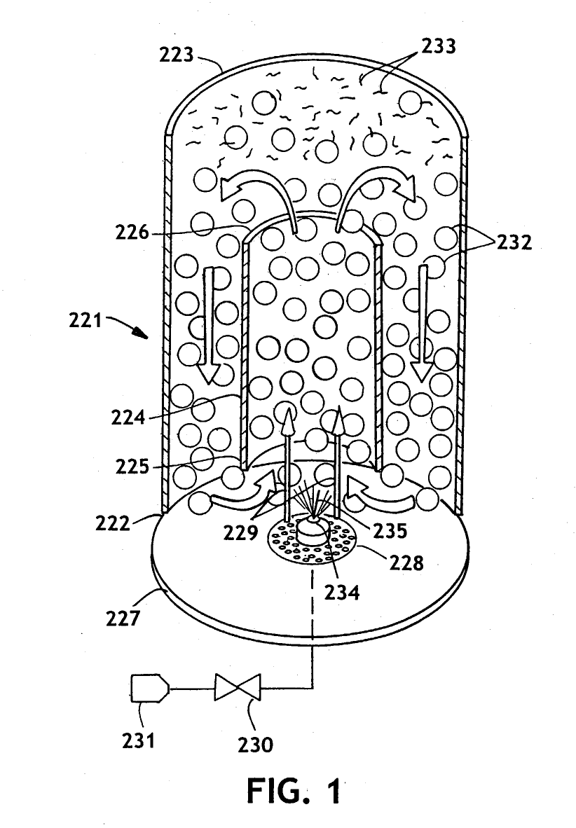

A fluidized bed coating apparatus similar to that illustrated in FIG. 1 may be utilized to form the absorbent composites of the present invention. Referring to FIG. 1, a generally vertically-mounted, generally cylindrical chamber (221) is open at chamber proximal end (222) and closed at chamber distal end (223). The chamber (221) is optionally provided with an inner chamber (224) that has a diameter less than that of the chamber. The inner chamber (224) is open at both inner chamber proximal end (225) and inner chamber distal end (226). The chamber proximal end (222) is fitted with a plate (227) that has a porous area (228) that generally matches the diameter of the inner chamber (224). The inner chamber (224) is positioned a distance above the plate (227) and is generally aligned along the vertical axis of the chamber (221). Through the porous area (228) is provided an upward current or stream (229) of fluidizing gas, usually air, typically at an inlet temperature approximating that of room temperature, such as from a valve (230) from a source of compressed gas (231). The upward-moving stream (229) of fluidizing gas generally flows through the inner chamber (224) by entering through the inner chamber proximal end (225) and exiting through the inner chamber distal end (226). As described in one of the previously mentioned process embodiments, at least one particle of energy receptive additive (233) is introduced into the chamber (221). The upward-moving stream (229) of fluidizing gas is adjusted so as to provide a fluid-like flow to the energy receptive additive (233). The upward-moving stream (229) of gas moves the energy receptive additive (233) upward until the energy receptive additive passes out of the upward stream and passes downward in a fluidized condition countercurrent to the upward-moving stream of fluidizing gas. The energy receptive additive (233) may re-enter the upward-moving stream (229) of fluidizing gas. While in the upward-moving stream, the energy receptive additive passes through a zone where an association agent (235) is applied to the energy receptive additive (233). This zone is generally located in the vicinity of a sprayer means (234) positioned near the center of the plate (227). After the association agent is applied to the energy receptive additive (233), at least one particle of superabsorbent material (232) is introduced into the chamber (221). If necessary, the upward-moving stream (229) of gas is adjusted so as to provide a fluid-like flow to the superabsorbent material (232) and the energy receptive additive (233). After introduction of the superabsorbent material (232), the inlet temperature of the upward-moving stream (229) of fluidizing gas is optionally elevated to a temperature in excess of room temperature. The cyclic flow of the superabsorbent material (232) and the energy receptive additive (233) would generally be allowed to continue in the chamber (221) until the energy receptive additive comes into intimate association with the superabsorbent material to form an absorbent composite. The absorbent composite is then recovered or removed from the chamber (221). The absorbent composite so formed would include at least one particle of superabsorbent material covered with at least a first layer of at least one particle of energy receptive additive. The energy receptive additive of the first layer would be in intimate association with and covering the surface of the superabsorbent material.

A fluidized bed coating process is relatively mild in its effect on the superabsorbent material being brought into intimate association with the energy receptive additive and would therefore be less damaging to the microstructure of the superabsorbent material as compared to other processes. Although discussed in terms of being formed in a fluidized bed coating process, the absorbent composites of the present invention may also be formed using a variety of other processes incorporating, for example, a V-shell blender or other apparatus that is relatively mild in its effect on the superabsorbent material.

Optionally, after formation, the absorbent composite of the present invention may remain in the apparatus and subject to the strong upward current or stream of fluidizing gas at an elevated temperature until the moisture content of the absorbent composite is less than that which would support the growth of microorganisms. Without desiring to be bound by theory, it is believed that to minimize the likelihood of the growth of microorganisms, the moisture content of the absorbent composites should be about 15 percent or less by weight; desirably, about 10 percent or less by weight; more desirably, about 5 percent or less by weight; and most desirably, about 3 percent or less by weight. Although embodiments of the process have been described herein as optionally drying absorbent composites in the apparatus, the optional drying of a absorbent composite could be accomplished either in the apparatus or out of the apparatus according to any of a number of other drying processes known to those skilled in the art.

Depending on the intended use of the absorbent composite, it may be desired to add a second energy receptive additive to an absorbent composite. The second energy receptive additive, as well as any subsequent additional energy receptive additive, would be added in generally the same manner as would a first receptive additive according to at least one of the process embodiments described herein.

Although previously described herein as having a one- or two-energy receptive additive configuration, it is also within the present invention to form absorbent composites having more than two energy receptive additives. Consequently, it is within the scope of the present invention to form absorbent composites having a single energy receptive additive or absorbent composites having two or more energy receptive additives in a variety of multi-layered or multi-mixture configurations with each energy receptive additive-containing layer or mixture including one or more energy receptive additives.

Various embodiments of the process described herein may operate at inlet temperatures ranging from about room temperature to about 72° C. The inlet temperature may, however, range considerably higher than about 72° C. so long as the bed temperature in the apparatus does not exceed a temperature that would cause decomposition of the absorbent composite or any material included in the absorbent composite. The selection of a particular inlet temperature would depend on the superabsorbent material, the energy receptive additive and the optional association agent, and may be readily selected by one skilled in the art.

It is desired that an absorbent composite of the present invention has a weight ratio, based on the total weight of the superabsorbent material and the energy receptive additive in the absorbent composite, of superabsorbent material to energy receptive additive of from about 99:1 to about 1:99; alternatively, from about 45:55 to about 95:5; alternatively, from about 60:40 to about 80:20; and finally, alternatively, from about 65:35 to about 70:30.

### EXAMPLES

The following Examples describe various embodiments of the invention. Other embodiments within the scope of the claims herein will be apparent to one skilled in the art from consideration of the specification or practice of the invention as disclosed herein. It is intended that the specification, together with the Examples, be considered exemplary only, with the scope and spirit of the invention being indicated by the claims which follow the Examples.

### Example 1

This Example illustrates an alternate method of preparing the absorbent composites disclosed herein. DRYTECH 2035 superabsorbent, available from Dow Chemical Company, Midland, Mich., U.S.A., was sieved to 300-600 micron particle size using standard sieves. Also utilized in this example was India Ink, a source of carbon black, available in solution form from Speedball Art Products Company, 2226 Speedball Road., Statesville, N.C., U.S.A. The solids content of the India Ink was determined separately to be about 21 percent.

Specifically, an energy receptive additive, in the form of the India Ink solution, was mixed 1:1 with DRYTECH 2035 superabsorbent. The mixing occurred in a weighing dish using a spatula. The weighing dish and its contents were thereafter placed in an oven and dried at about 105° C. for approximately 1 hour. The absorbent composite so formed contained approximately 83 percent (by weight) superabsorbent and approximately 17 percent (by weight) energy receptive additive.

### Example 2

This Example illustrates still another method of preparing the absorbent composites disclosed herein. DRYTECH 2035 superabsorbent, available from Dow Chemical Company, Midland, Mich., U.S.A., was sieved to 300-600 micron particle size using standard sieves. Also utilized in this example was a source of graphite in the form of a graphite stick, item No. 970A-BP, available from General Pencil Company, Inc., Jersey City, N.J.

Graphite, an energy receptive additive, was obtained by grinding the graphite stick in a mortar and pestle. The ground graphite was sieved such that particles of graphite having a size of less than 150 microns were utilized in this example. The ground graphite particles were mixed 4:1 with DRYTECH 2035 superabsorbent. The mixing occurred by placing the mixture in a sealed bottle and shaking vigorously by hand for a few minutes. A small amount of association agent (e.g., water) may also be utilized.

### Example 3

This Example illustrates yet another method of preparing the absorbent composites disclosed herein. DRYTECH 2035 superabsorbent, available from Dow Chemical Company, Midland, Mich., U.S.A., was sieved to 300-600 micron particle size using standard sieves. Also utilized in this example was a source of graphite in the form of a graphite stick, item No. 970A-BP, available from General Pencil Company, Inc., Jersey City, N.J.

Graphite, an energy receptive additive, was obtained by grinding the graphite stick in a mortar and pestle. The ground graphite was sieved such that particles of graphite having a size of 150-300 microns were utilized in this example. The ground graphite particles were mixed 4:1 with DRYTECH 2035 superabsorbent. The mixing occurred by placing the mixture in a sealed bottle and shaking vigorously by hand for a few minutes. A small amount of association agent (e.g., water) may also be utilized.

In view of the above, it will be seen that the several advantages of the invention are achieved and other advantageous results attained.

As various changes could be made in the above processes and absorbent composites without departing from the scope of the invention, it is intended that all matter contained in the above description and shown in the accompanying drawing shall be interpreted as illustrative and not in a limiting sense.

What is claimed is:

1. An absorbent composite comprising a superabsorbent material and an energy receptive additive, the energy receptive additive having a dielectric loss tangent of at least about 0.15.

2. The composite of claim 1, wherein the surface of the superabsorbent material is covered with the energy receptive additive.

3. The composite of claim 2, wherein the energy receptive additive is in intimate association with the surface of the superabsorbent material.

4. The composite of claim 3, wherein the dielectric loss tangent is measured at a frequency of about 915 MHz.

5. The composite of claim 4, wherein the energy receptive additive has a dielectric loss tangent of at least 0.15.

6. The composite of claim 5, wherein the intimate association of the energy receptive additive with the superabsorbent material is achieved with the use of an association agent.

7. The composite of claim 4, wherein the energy receptive additive has a dielectric loss tangent of at least about 0.25.

8. The composite of claim 7, wherein the energy receptive additive has a dielectric loss tangent of at least 0.25.

9. The composite of claim 8, wherein the intimate association of the energy receptive additive with the superabsorbent material is achieved with the use of an association agent.

10. The composite of claim 4, wherein the energy receptive additive has a dielectric loss tangent of at least about 0.5.

11. The composite of claim 10, wherein the energy receptive additive has a dielectric loss tangent of at least 0.5.

12. The composite of claim 11, wherein the intimate association of the energy receptive additive with the superabsorbent material is achieved with the use of an association agent.

13. An absorbent composite comprising a superabsorbent material and an energy receptive additive, the energy receptive additive having a dielectric constant of at least about 4.

14. The composite of claim 13, wherein the surface of the superabsorbent material is covered with the energy receptive additive.

15. The composite of claim 14, wherein the energy receptive additive is in intimate association with the surface of the superabsorbent material.

16. The composite of 15, wherein the dielectric constant is measured at a frequency of about 915 MHz.

17. The composite of claim 16, wherein the energy receptive additive has a dielectric constant of at least 4.

18. The composite of claim 17, wherein the intimate association of the energy receptive additive with the superabsorbent material is achieved with the use of an association agent.

19. The composite of claim 16, wherein the energy receptive additive has a dielectric constant of at least about 8.

20. The composite of claim 19, wherein the energy receptive additive has a dielectric constant of at least 8.

21. The composite of claim 20, wherein the intimate association of the energy receptive additive with the superabsorbent material is achieved with the use of an association agent.

22. The composite of claim 16, wherein the energy receptive additive has a dielectric constant of at least about 15.

23. The composite of claim 22, wherein the energy receptive additive has a dielectric constant of at least 15.

24. The composite of claim 23, wherein the intimate association of the energy receptive additive with the superabsorbent material is achieved with the use of an association agent.

24. A microwave heatable absorbent composite comprising a superabsorbent material and an energy receptive additive, the energy receptive additive (i) being in intimate association with and covering the surface of the superabsorbent material and (ii) heating up in the presence of microwave energy.

25. The composite of claim 24, wherein the energy receptive additive has a dielectric loss tangent of at least about 0.15.

26. The composite of claim 25, wherein the dielectric loss tangent is measured at a frequency of about 915 MHz.

27. The composite of claim 26, wherein the energy receptive additive has a dielectric constant of at least about 4 at a frequency of about 915 MHz.

28. The composite of claim 26, wherein the intimate association of the energy receptive additive with the superabsorbent material is achieved with the use of an association agent.

29. The composite of claim 26, wherein the energy receptive additive has a dielectric loss tangent of at least about 0.25.

30. The composite of claim 29, wherein the energy receptive additive has a dielectric constant of at least about 4 at a frequency of about 915 MHz.

31. The composite of claim 30, wherein the intimate association of the energy receptive additive with the superabsorbent material is achieved with the use of an association agent.

32. The composite of claim 26, wherein the energy receptive additive has a dielectric loss tangent of at least about 0.5.

33. The composite of claim 32, wherein the energy receptive additive has a dielectric constant of at least about 4 at a frequency of about 915 MHz.

34. The composite of claim 33, wherein the intimate association of the energy receptive additive with the superabsorbent material is achieved with the use of an association agent.
